(19) United States
(12) Patent Application Publication
(10) Pub. No.: US 2022/0321924 A1
(43) Pub. Date: Oct. 6, 2022

(54) COMMUNICATION APPARATUS, CONTROL METHOD, AND RECORDING MEDIUM

(71) Applicant: CANON KABUSHIKI KAISHA, Tokyo (JP)

(72) Inventor: Naoto Toshima, Tokyo (JP)

(21) Appl. No.: 17/703,772

(22) Filed: Mar. 24, 2022

(30) Foreign Application Priority Data
Mar. 30, 2021 (JP) 2021-058483

(51) Int. Cl. H04N 21/2187; H04N 21/2743; H04L 65/611; H04L 65/612

(52) U.S. Cl. CPC H04N 21/2187; H04N 21/2743; H04L 65/4076; H04L 65/4084

(57) ABSTRACT

A communication apparatus includes an imaging unit, a recording unit, a control unit, and a communication unit. The control unit controls the imaging unit to generate first moving image data. In starting transmission of the first moving image data currently being generated by the imaging unit to an external apparatus, the control unit controls the communication unit to automatically transmit second moving image data different from the first moving image data, before starting the transmission of the first moving image data, where second moving image data is recorded in the recording unit.

### BACKGROUND

### Field

The present disclosure relates to a communication apparatus capable of switching moving image data to be transmitted.

### Description of the Related Art

In recent years, live distribution services are known to distribute moving image data and audio data in real time. The user can send data generated by using a camera and a microphone mounted on a communication apparatus, such as a smart phone or a digital camera, to other users in real time via a live distribution service. Japanese Patent Application Laid-Open No. 2020-106932 discusses a digital camera capable of performing live distribution, for example.

Examples of methods for attracting more viewers to view a live distribution include a method in which an opening moving image is distributed before the live distribution and an ending moving image is distributed after the live distribution to attract viewers. For example, in some cases, in a case where an opening moving image is to be distributed, a user acting as a distributor may complete the distribution of the opening moving image data and then perform an operation for manually switching to distribution of the moving image data currently being generated in real time.

However, in many cases, the user acting as a distributor does not wish to show the image of the user performing an operation for manually switching between a plurality of moving image data pieces, to other users who are viewers. Conventionally, it has been necessary for the user acting as a distributor to take certain measures to prevent such images of the distributor from being viewed by the other users who are viewers of the moving images. Thus, switching among a plurality of moving image data pieces in distribution of moving images has typically required additional work by the user performing the distribution work that is unnecessary for the distribution itself.

### SUMMARY

According to various embodiments of the present disclosure, a communication apparatus is provided that includes an imaging unit, a recording unit, a control unit, and a communication unit. The control unit controls the imaging unit to generate first moving image data. In starting transmission of the first moving image data currently being generated by the imaging unit to an external apparatus, the control unit controls the communication unit to automatically transmit second moving image data different from the first moving image data, before starting the transmission of the first moving image data, where the second moving image data is recorded in the recording unit.

Further features of the present disclosure will become apparent from the following description of example embodiments with reference to the attached drawings.

### BRIEF DESCRIPTION OF THE DRAWINGS

FIG. 1A illustrate an example of a configuration of a digital camera according to a first example embodiment, and FIGS. 1B and 1C illustrate examples of outer appearances of a digital camera according to the first example embodiment.

FIG. 2 illustrates an example of a system configuration of a live distribution service according to the first example embodiment.

FIGS. 3A to 3F illustrate examples of live distribution setting screens of the digital camera according to the first example embodiment.

FIG. 4 is a sequence diagram illustrating an example of processing which is performed by the digital camera and a distribution server according to the first example embodiment.

FIGS. 5A to 5H illustrate examples of display screens of the digital camera and examples of moving image data distributed by the distribution server during live distribution according to the first example embodiment.

FIG. 6 is a flowchart illustrating an example of an operation of the digital camera according to the first example embodiment.

FIGS. 7A and 7B illustrate an example of an operation of the digital camera during opening moving image distribution according to the first example embodiment.

FIGS. 8A and 8B illustrate examples of display screens of the digital camera during opening moving image distribution according to the first example embodiment.

### DESCRIPTION OF THE EMBODIMENTS

Example embodiment of the present disclosure will be described in detail below with reference to the accompanying drawings.

The following example embodiments are to be considered as illustrative examples for implementing features of the present disclosure, and may be corrected, modified, and combined as appropriate depending on the configuration of an apparatus to which the present disclosure is applied and other various conditions. The example embodiments may be appropriately combined.

### First Example Embodiment

### <Configuration of Digital Camera>

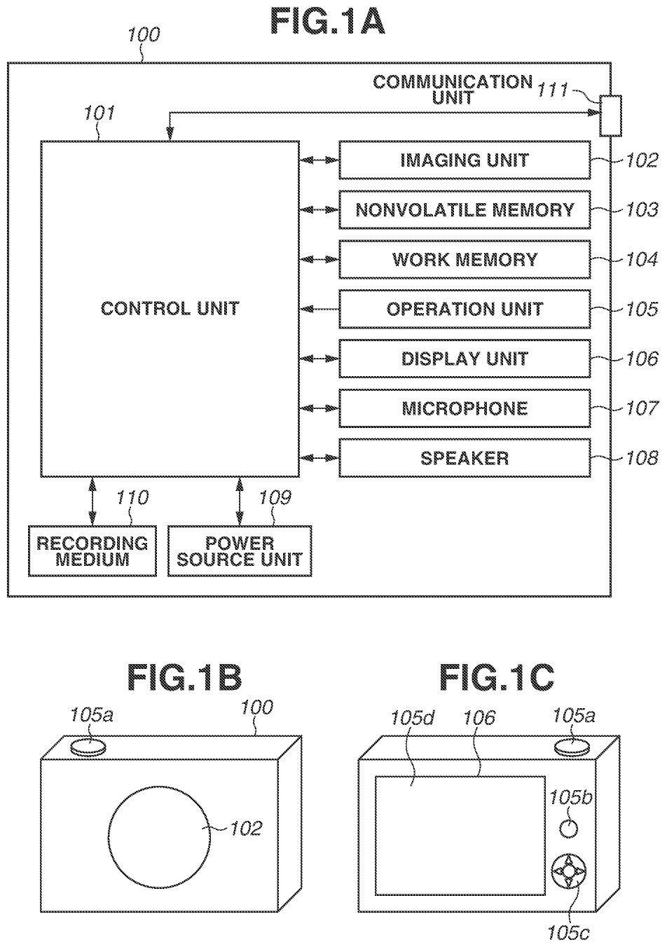

FIG. 1A is a block diagram illustrating an example of a configuration of a digital camera 100 which is an example of a communication apparatus according to a first example embodiment. A digital camera will be described below as an example of a communication apparatus, the communication apparatus is not limited thereto. Examples of communication apparatuses include smart phones, personal computers, smart watches, and tablet terminals.

A control unit 101 includes hardware component (e.g., a processor) for executing a program stored in a nonvolatile memory 103. The control unit 101 executes the program recorded in the nonvolatile memory 103 to control the digital camera 100. Instead of being controlled by the control unit 101, the entire apparatus may be controlled by a plurality of hardware components that share processing.

An imaging unit 102 includes, for example, a lens unit, an image sensor for converting the optical image of a subject formed on an imaging plane through the lens unit into an electrical signal, and an image processing unit that generates still image data or moving image data from the electrical signal generated by the image sensor. A Complementary Metal Oxide Semiconductor (CMOS) sensor or a Charge Coupled Device (CCD) sensor is generally used as the image sensor. According to the first example embodiment, a series of processes in which the imaging unit 102 generates still image data or moving image data and then outputs the image data is referred to as “image capturing”. The still image data or moving image data generated by the imaging unit 102 is recorded in a recording medium 110 in accordance with the Design rule for Camera File system (DCF) standard. The still image data and moving image data to be transmitted for live distribution (described below) are temporarily recorded in a work memory 104 and then transmitted. These pieces of data are transmitted to a distribution server 300 via a communication unit 111. The imaging unit 102 may be configured to be attachable to and detachable from the digital camera 100 or may be built in the digital camera 100. More specifically, it is only required for the digital camera 100 to include at least means for acquiring an electrical signal of moving image data and the like from the imaging unit 102.

The nonvolatile memory 103 records thereon programs to be executed by the control unit 101. The control unit 101 can record moving image data and/or still image data in the nonvolatile memory 103.

The work memory 104 is used as a buffer memory for temporarily storing still image data and moving image data imaged by the imaging unit 102, an image display memory for the display unit 106, and a work area for the control unit 101.

An operation unit 105 is a user interface (UI) for receiving instructions to the digital camera 100 from the user. The operation unit 105 can include a power switch for issuing an instruction to turn power of the digital camera 100 ON and OFF, a release switch for issuing an image-capturing instruction, and a reproduction button for issuing an instruction to reproduce still image data. The operation unit 105 can also include the touch panel formed on the display unit 106. The release switch includes switch (SW) 1 and SW 2. In response to the release switch being half-pressed, the SW 1 turns ON. Thus, the operation unit 105 receives a preparation instruction to perform imaging preparation operations, such as automatic focus (AF) processing, automatic exposure (AE) processing, automatic white balance (AWB) processing, and flash preliminary emission (EF) processing. In response to the release switch being fully pressed, the SW 2 turns ON. With these user operations, the digital camera 100 receives an imaging instruction to perform an imaging operation. The operation unit 105 also includes a wireless button for switching the wireless communication function ON and OFF via the communication unit 111.

The display unit 106 displays a through-the-lens image for image capturing, captured still image data, and texts for interactive operations. The display unit 106 is, for example, a liquid crystal display or a light emitting diode (LED) display. The display unit 106 may not be built in the digital camera 100 but may be externally connected to the digital camera 100. More specifically, the digital camera 100 can connect with the internal or external display unit 106 and may include at least a function of controlling the display of the display unit 106. The external display unit 106 is, for example, a view finder that can be connected to the digital camera 100.

A microphone 107 is a microphone apparatus that collects an acoustic wave such as voice and generates audio data. The control unit 101 can generate moving image data with sound from the moving image data generated by the imaging unit 102 and the audio data generated by the microphone 107 or an external microphone apparatus. The moving image data with sound generated by the control unit 101 is recorded in the recording medium 110 by the control unit 101. The control unit 101 can also record the still image data generated by the imaging unit 102 and the audio data generated by the microphone 107 in the recording medium 110 in association with each other. The audio data generated to be transmitted for live distribution (described below) is recorded in the work memory 104. The microphone 107 may be configured to be attachable to and detachable from the digital camera 100, or built in the digital camera 100. More specifically, the digital camera 100 needs to have at least a means for receiving an electrical signal from the microphone 107. Processing performed by the microphone 107 to generate audio data from an acoustic wave may be partly borne by other hardware components (e.g., the control unit 101).

A speaker 108 is an electroacoustic transducer capable of outputting electronic sound data. Examples of electronic sound data include musical pieces, warning sounds, focusing sounds, electronic shutter sounds, and operation sounds.

These pieces of electronic sound data are recorded in the nonvolatile memory 103. The speaker 108 can output electronic sound data selected by the control unit 101. By hearing the sound output from the speaker 108, the user can notice the in-focus state of a subject and an error occurring in the digital camera 100.

A power source unit 109 under the control of the control unit 101 can supply power to each element of the digital camera 100. The power source unit 109 is, for example, a lithium-ion battery or an alkali manganese dry battery.

The recording medium 110 can record, for example, the still image data output from the imaging unit 102. Examples of the recording medium 110 include a Secure Digital (SD) card, a Compact Flash (CF) card, and an XQD (registered trademark) card. The recording medium 110 may be configured to be attachable to and detachable from the digital camera 100, or built in the digital camera 100. More specifically, it is only required for the digital camera 100 to have at least means for accessing the recording medium 110.

The communication unit 111 is an interface for wirelessly connecting to an external apparatus. The digital camera 100 according to the present example embodiment can perform data transmission and reception with an external apparatus via the communication unit 111. For example, the digital camera 100 can transmit the still image data generated by the imaging unit 102 and the moving image data recorded in the nonvolatile memory 103, to an external apparatus via the communication unit 111. The external apparatus according to the present example embodiment is, for example, a communication apparatus, such as an external server, a smart phone, and a personal computer (PC). According to the present example embodiment, the communication unit 111 includes an interface that communicates with a relay apparatus and an external apparatus in accordance with a wireless Local Area Network (LAN) conforming to the IEEE 802.11 standard. According to the present example embodiment, the communication unit 111 of the digital camera 100 is provided with a client mode in which the communication unit 111 operates as a client in an infrastructure mode. By operating the communication unit 111 in the client mode, the digital camera 100 according to the present example embodiment can operate as a client apparatus in the infrastructure mode.

Connecting the digital camera 100 operating as a client apparatus to a peripheral access point apparatus enables the digital camera 100 to participate in a LAN formed by the access point apparatus. The control unit 101 implements wireless communication with a relay apparatus and an external apparatus by controlling the communication unit 111. The communication method is not limited to a wireless LAN. Examples of applicable communication methods include public wireless communication methods, such as 4th Generation Mobile Communication System (4G), Long Term Evolution (LTE), and 5th Generation Mobile Communication System (5G), wire lined communication methods conforming to Ethernet, and wireless communication methods such as Bluetooth®.

An example of an outer appearance of the digital camera 100 will be described below. FIG. 1B illustrates an example of an external view of the front face of the digital camera 100. FIG. 1C illustrates an example of an external view of the rear face of the digital camera 100. A release switch 105a, a reproduction button 105b, arrow keys 105c, and a touch panel 105d are operation members included in the operation unit 105. The release switch 105a, the reproduction button 105b, the arrow keys 105c, and the touch panel 105d are operation members used to enter various operation instructions to the control unit 101. The display unit 106 displays a still image or a moving image imaged by the imaging unit 102.

This completes the description of an example configuration of the digital camera 100.

### <System Configuration of Live Distribution>

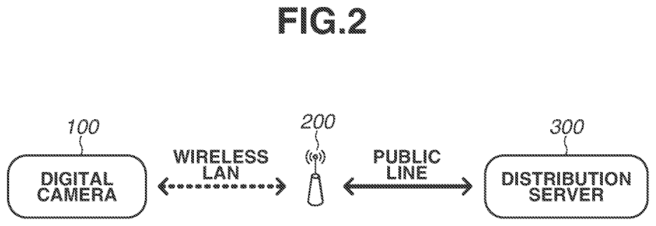

FIG. 2 illustrates an example of a system configuration in which the digital camera 100 accesses the distribution server 300 via a network to perform live distribution.

A network router 200 serves as an access point of a wireless LAN and forms a network. The digital camera 100 participates in the network formed by the network router 200, as a client, using the communication unit 111. The digital camera 100 connects to the distribution server 300 via the network router 200. While an example will be described below in which the digital camera 100 wirelessly connects to the network router 200 in the present example embodiment, the digital camera 100 may connect to the network router 200 using wire. For example, the network router 200 may also be an information processing apparatus, such as a smart phone, a tablet device, and a personal computer. In such a case, the network formed by the network router 200 is formed by the tethering function of the information processing apparatus.

The distribution server 300 provides cloud services. In particular, the user demands a provision of content with a small delay amount from this cloud service. According to the present example embodiment, the distribution server 300 provides live distribution services.

Live distribution is a process in which the user acting as a distributor distributes moving image data and/or audio data to users as viewers in real time via the Internet, by using a streaming technique. The users as viewers can view the moving image data and/or audio data in real time, as in a live program of television and radio broadcasting. As a live distribution service, the distribution server 300 transmits, as content, moving image data and/or audio data transmitted from the user acting as a distributor, to the viewers. According to the present example embodiment, the digital camera 100 successively transmits the moving image data generated in real time to the distribution server 300, and the distribution server 300 successively transmits the received moving image data to the users as viewers. In addition, the distribution server 300 also provides such a service that the users as viewers can view the live distribution through web pages. Hereinafter, moving image data and/or audio data generated by the digital camera 100 and then distributed in the live distribution are collectively referred to as distribution data.

Before starting the live distribution, the user acting as a distributor makes live distribution settings on the distribution server 300 by using a PC or a smart phone. The live distribution settings include data to be used to set moving image data as the content to be provided in the live distribution, and to transmit and receive the moving image data. Examples of the live distribution settings include the identifier of the live distribution, distribution destination Uniform Resource Locator (URL), stream key, the title of the live distribution, the frame rate of the moving image data, and the bit rate of the moving image data. The distribution destination URL is, for example, the transmission destination of the distribution data generated by the digital camera 100. The stream key is information used by the distribution server 300 to associate the user with the distribution data.

The user can generate a plurality of live distribution settings in the distribution server 300. For example, in a case where the user acting as a distributor performs the live distribution with different distribution content in succession, the user acting as a distributor makes the live distribution settings on the distribution server 300 for each live distribution. The user can also make the live distribution settings by using the digital camera 100. In this case, the digital camera 100 transmits the made live distribution settings to the distribution server 300, and the distribution server 300 records the live distribution settings.

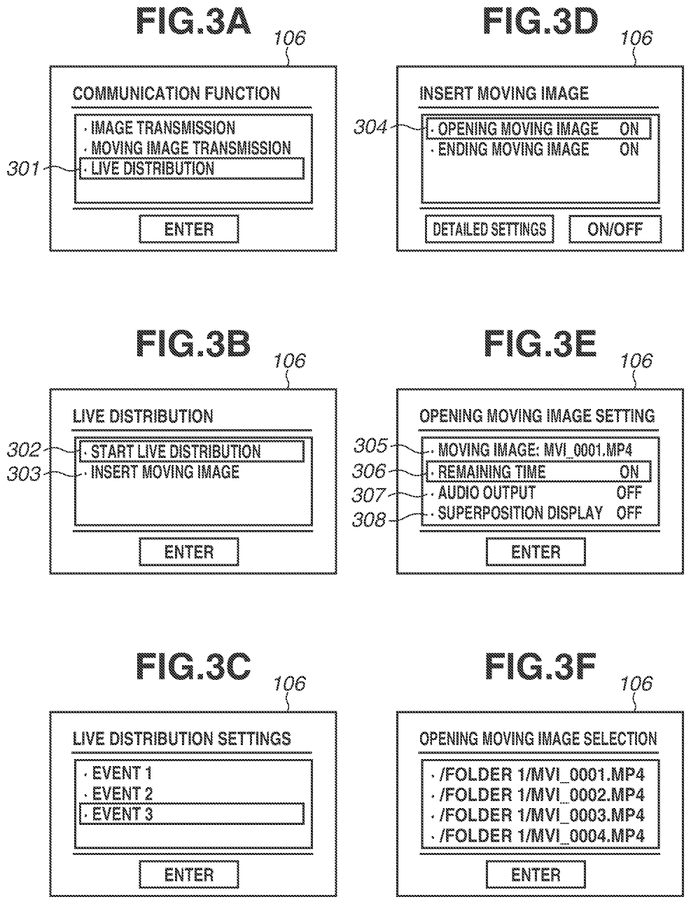

In performing the live distribution, the digital camera 100 transmits the distribution data in accordance with the live distribution settings received from the distribution server 300. User operations for starting the live distribution will be described below with reference to FIGS. 3A to 3C. FIG. 3A illustrates an example of a screen for displaying a list of communication functions of the digital camera 100. In performing the live distribution, the user selects “Live Distribution”, the item 301, and presses the ENTER button to finalize the setting by using the operation unit 105. In this case, the digital camera 100 displays the screen illustrated in FIG. 3B.

FIG. 3B illustrates an example of a screen for displaying setting items related to the live distribution. According to the present example embodiment, the digital camera 100 displays an item 302 for starting the live distribution, and an item 303 for setting whether to insert moving images in the live distribution. In a case where the live distribution is started, the user selects the item 302 and then presses the ENTER button to finalize the setting using the operation unit 105. In this case, the digital camera 100 displays the screen illustrated in FIG. 3C. The item 303 will be described below.

FIG. 3C illustrates an example of a screen for selecting a live distribution setting. This screen displays a list of live distribution settings received by the digital camera 100 from the distribution server 300. Each item name displayed in this screen is, for example, the title of a live distribution. In a case where the user selects any one item and then presses the ENTER button to finalize the setting, the digital camera 100 starts the live distribution processing based on the selected live distribution setting. The live distribution processing will be described in detail below.

The communication protocol used by the digital camera 100 and the distribution server 300 to transmit and receive data for live distribution preparation processing is different from the communication protocol used to transmit and receive distribution data in the live distribution. The former protocol is a communication protocol that enables data communication. The former communication protocol is assumed to be a widely used communication protocol. The latter communication protocol is a communication protocol intended for communication with a small delay amount. Examples of the former communication protocol include Hypertext Transfer Protocol (HTTP), and examples of the latter communication protocol include Real-Time Messaging Protocol (RTMP). Communications conforming to the latter communication protocol (RTMP) have a feature that the delay amount is smaller than that in communications conforming to the former communication protocol (HTTP). According to the present example embodiment, the digital camera 100 transmits through RTMP the distribution data to be distributed in the live distribution and transmits other pieces of data (e.g., the live distribution settings) through HTTP.

### <Opening Distribution Function>

In the present example embodiment, in a case where the digital camera 100 starts the live distribution, prior to the successive transmission of the moving image data generated by the imaging unit 102, as distribution data, the digital camera 100 can transmit the moving image data recorded in the recording medium 110 to the distribution server 300, as distribution data.

Hereinafter this function is referred to as an opening distribution function. The moving image data recorded in the recording medium 110 is, for example, moving image data for the opening moving image. The opening moving image is used to notify the users as viewers that the live distribution will soon be started. In a case where the user changes the distribution data, normally, the user is to perform operations for selecting and changing the distribution data to be transmitted. However, with the foregoing opening distribution function, the user does not need to perform such an operation since the opening distribution function of the digital camera 100 automatically changes the distribution data from the moving image data of the opening moving image to the moving image data generated by the imaging unit 102. This enables the user to naturally change the distribution data from the moving image data of the opening moving image to the moving image data generated by the imaging unit 102 by performing an operation for starting the live distribution alone. A method for the user to use the opening distribution function according to the present example embodiment will be described below.

According to the present example embodiment, in a case where the opening distribution function is used, the user selects the item 303 illustrated in FIG. 3B and then presses the ENTER button to finalize the setting. In this case, the digital camera 100 displays the screen illustrated in FIG. 3D.

The screen in FIG. 3D is used to determine whether to insert a moving image in the live distribution. Descriptions of the functions other than the opening distribution function will be omitted. In a case where the user uses the opening distribution function, the user selects an item 304 and then presses an “ON/OFF” button. The user can thus switch between use and nonuse of the opening distribution function.

Further, in a case where detailed settings of the opening distribution function is to be changed, the user presses a “Detailed Settings” button. In response to this button depression, the digital camera 100 displays a screen for setting details of the opening distribution function.

FIG. 3E illustrates a screen for displaying a list of detailed settings of the opening distribution function.

In a case where the user selects an item 305, the digital camera 100 displays a screen for selecting the moving image data to be distributed using the opening distribution function, as illustrated in FIG. 3F.

In the screen illustrated in FIG. 3F, the user selects the moving image data to be distributed as the opening moving image and presses the ENTER button to finalize the setting. The digital camera 100 displays the name of the moving image data thus finalized at the item 305. Settings of items 306 to 308 will be described below.

Thus, the user can use the opening distribution function.

An item “Ending Moving Image” in FIG. 3D will be described below. In a case where the item “Ending Moving Image” is ON, the digital camera 100 operates as follows. In a case where the digital camera 100 terminates the live distribution, the digital camera 100 transmits the moving image data recorded in the recording medium 110 to the distribution server 300 as distribution data after completing the transmission of the moving image data generated by the imaging unit 102 before transmitting a live distribution end request. Hereinafter this function is referred to as an ending distribution function. The moving image data recorded in the recording medium 110 is, for example, an ending moving image. The ending moving image is used to notify the users as viewers that the live distribution is to be ended. The ending distribution function saves the user from having to perform an operation for selecting the distribution data to be distributed to distribute the ending moving image. According to the present example embodiment, the method for the user to use the ending distribution function is similar to the method for the opening distribution function.

### <Live Distribution Processing>

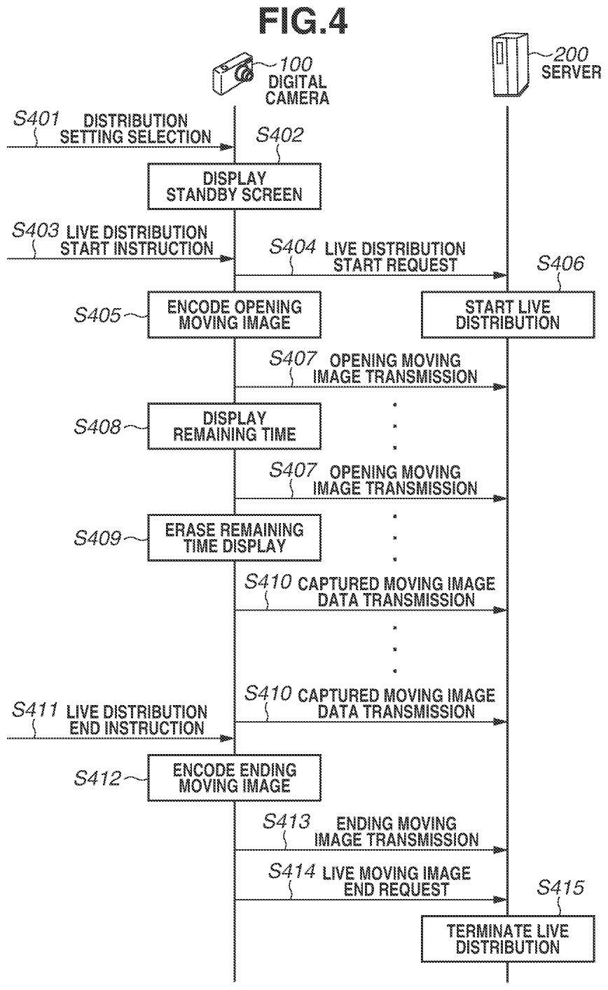

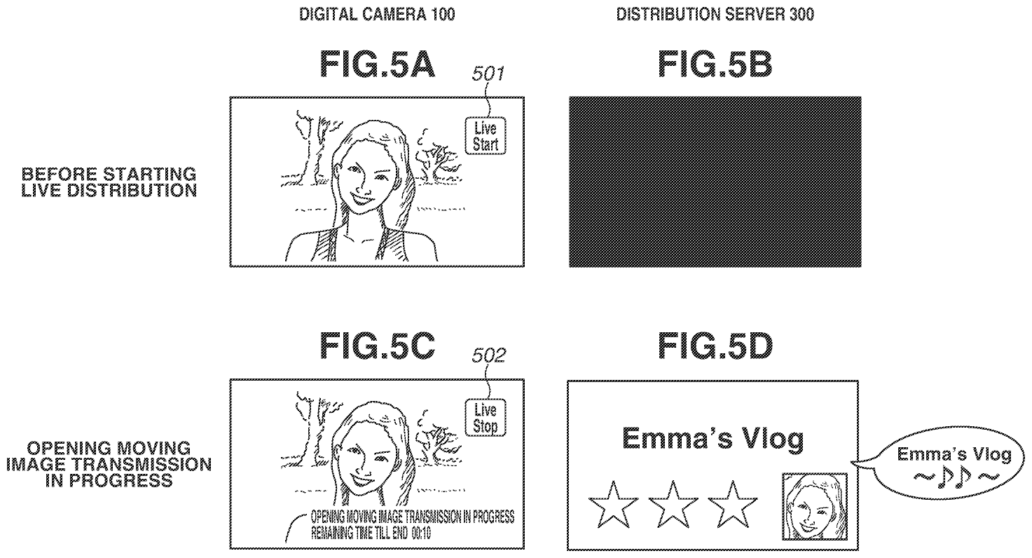

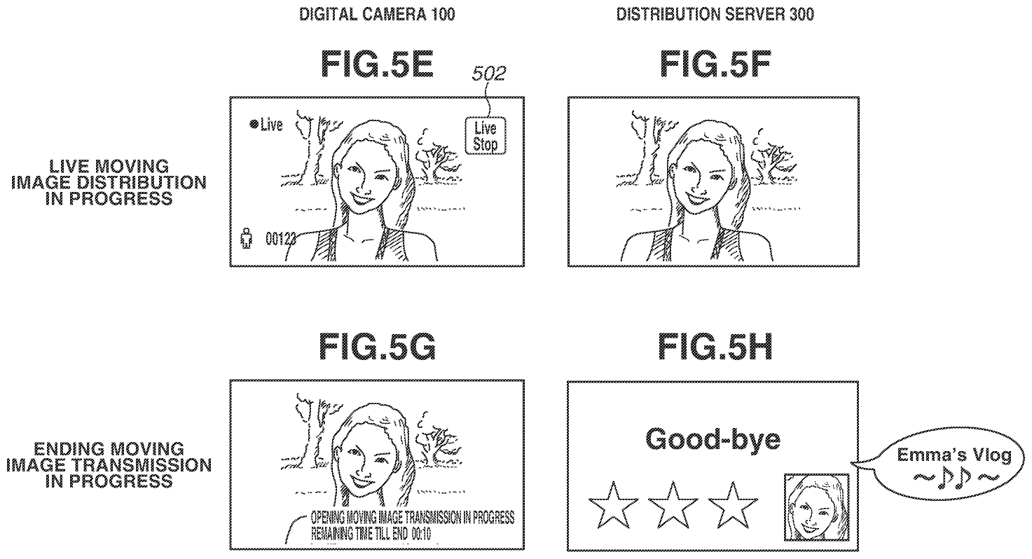

FIG. 4 illustrates an example of a processing sequence which is performed by the digital camera 100 and the distribution server 300 at the time of execution of the live distribution according to the present example embodiment. FIGS. 5A to 5H illustrate examples of display screens of the digital camera 100 according to the present example embodiment. A series of operations in the live distribution will be described below with reference to FIGS. 5A to 5H.

In step S401, the user operates the digital camera 100 to enter an instruction to start a live distribution. For example, as described above, the user selects any one of live distribution settings and presses the ENTER button to finalize the setting by performing a touch operation in the screen illustrated in FIG. 3C on the touch panel.

In step S402, the digital camera 100 displays a standby screen. The user can adjust the arrangement and image capturing settings, such as the angle of view and white balance, of the digital camera 100 while referring to the standby screen. FIG. 5A illustrates an example of a standby screen before the live distribution is started. As illustrated in FIG. 5A, the digital camera 100 successively displays the moving image data currently being generated by the imaging unit 102, on the display unit 106. On the other hand, as illustrated in FIG. 5B, the distribution server 300 has not yet received the distribution data from the digital camera 100, and thus the distribution data has not been transmitted to the users as viewers.

In a case where the live distribution preparation is completed after the processing in step S402 is performed, the user performs the operation in step S403 to start the live distribution. In this sequence, a description will be provided below of a case where the opening distribution function is enabled.

In step S403, the user operates the digital camera 100 to enter an instruction to start the distribution data transmission. For example, in the screen illustrated in FIG. 5A, the user performs a touch operation on the touch panel to select a button 501 to enter an instruction to start the live distribution processing.

In step S404, the digital camera 100 transmits a live distribution start request to the distribution server 300. The live distribution start request is a request to instruct the distribution server 300 to start the distribution data transmission to the users as viewers. This request includes the identifier and stream key of the live distribution.

In step S405, the digital camera 100 encodes the moving image data to be served as the opening moving image based on the live distribution settings and then generates the distribution data. For example, this live distribution settings relate to the moving image data, such as the resolution and frame rate that is receivable by the distribution server 300. In a case where the digital camera 100 determines that encoding is not necessary, the digital camera 100 may not omit the operation in this step.

In step S406, the distribution server 300 starts the live distribution based on the request received in step S404. For example, the distribution server 300 starts the transmission of the distribution data received from the digital camera 100, to the users as viewers. The processing in steps S405 and S406 is performed in parallel.

In step S407, the digital camera 100 transmits the distribution data of the opening moving image generated in step S405 to the distribution server 300. Subsequently, the digital camera 100 performs the processing in step S408 in parallel with the processing in step S407.

In step S408, the digital camera 100 displays the remaining time to completion of the transmission of the distribution data of the opening moving image. In the present example embodiment, the digital camera 100 superimposes the time on the moving image data currently being generated by the imaging unit 102 as illustrated in FIG. 5C. In the present example embodiment, the digital camera 100 does not reproduce the sound of the opening moving image in the screen illustrated in FIG. 5C. On the other hand, the distribution server 300 transmits the distribution data (i.e., the opening moving image) received from the digital camera 100 to the users as viewers as illustrated in FIG. 5D. The distribution data transmitted to the distribution server 300 also includes audio data. The viewers view and listen to the video and sound of the opening moving image. The digital camera 100 determines whether to display time to completion of the transmission of the distribution data of the opening moving image based on the setting of the item 306 in FIG. 3E.

In a case where the transmission of the distribution data of the opening moving image is completed, the digital camera 100 starts the transmission of the moving image data currently being generated by the imaging unit 102.

In step S409, the digital camera 100 erases the display of remaining time to completion of the transmission of the distribution data of the opening moving image because the transmission of the distribution data of the opening moving image is completed.

In step S410, the digital camera 100 transmits the moving image data currently being generated by the imaging unit 102 and the audio data currently being generated by the microphone 107 to the distribution server 300 as distribution data. In this step and subsequent steps, the digital camera 100 generates the moving image data currently being generated by the imaging unit 102 and the audio data currently being generated by the microphone 107, as successive distribution data, and then transmits the successive distribution data to the distribution server 300. The digital camera 100 transmits the distribution data in a predetermined amount of data. For example, in a case where moving image data for five seconds is recorded in the work memory 104, the digital camera 100 transmits previously captured moving image data for one second to the distribution server 300 as distribution data.

Here, FIG. 5E illustrates an example of a screen displayed during the live distribution of the digital camera 100 according to the present example embodiment. As illustrated in FIG. 5E, the digital camera 100 displays “●Live” at the top left of the display unit 106 to notify the user that the live distribution is in progress. In a case where data related to the live distribution status is received from the distribution server 300, the digital camera 100 may display the data on the display unit 106. Examples of the data related to the live distribution status include the number of viewers, the transmission rate of communication with the distribution server 300, numerical values related to the evaluation of the live distribution, and comments transmitted from the viewers to the distribution server 300 during the live distribution.

In the present example embodiment, in a case where data related to the number of viewers is received from the distribution server 300, the digital camera 100 displays the number of viewers at the bottom left of the display unit 106 as illustrated in FIG. 5E. The digital camera 100 may further display data related to other live distribution statuses on the display unit 106.

The distribution data to be transmitted to the distribution server 300 includes the moving image data generated by the imaging unit 102 of the digital camera 100 and the audio data generated by the microphone 107 thereof. As illustrated in FIG. 5F, the distribution server 300 transmits the distribution data received from the digital camera 100 to the users as viewers. The video of the distribution data is similar to the video that is displayed on the display unit 106 of the digital camera 100 (see FIG. 5E).

Subsequently, the user performs the live distribution by using the digital camera 100. In a case where the live distribution is to be ended, the user performs the operation in step S411 to end the live distribution. This sequence will be described below based on a case where the ending distribution function is enabled.

In step S411, the user operates the digital camera 100 to enter an instruction to end the transmission of the distribution data. In the screen illustrated in FIG. 5E, for example, the user performs a touch operation on the touch panel to select a button 502 to enter a live distribution end instruction.

In step S412, the digital camera 100 encodes the moving image data to be served as the ending moving image based on the live distribution settings to generate the distribution data. These live distribution settings relate to the moving image data are, for example, the resolution and frame rate that can be received by the distribution server 300. In a case where the digital camera 100 determines that encoding is not necessary, the digital camera 100 may omit the operation in this step.

In step S413, the digital camera 100 transmits the distribution data of the ending moving image generated in step S412 to the distribution server 300. Here, the digital camera 100 displays the remaining time to completion of the transmission of the distribution data of the ending moving image as illustrated in FIG. 5G. The distribution server 300 transmits the distribution data transmitted from the digital camera 100 to the users as viewers. In response to completion of the distribution data transmission, the digital camera 100 performs the operation in step S414.

In step S414, the digital camera 100 transmits a live distribution end request to the distribution server 300.

In step S415, the distribution server 300 terminates the live distribution based on the request received in step S404. For example, the distribution server 300 terminates the distribution data transmission to the users as viewers.

This completes the description of the live distribution processing according to the present example embodiment.

As described above, in response to a live distribution start instruction, the digital camera 100 transmits the opening moving image as the distribution data to the distribution server 300 before transmitting the moving image data generated by the imaging unit 102. In response to a live distribution end instruction, the digital camera 100 transmits the ending moving image as the distribution data to the distribution server 300 before transmitting a live distribution end request to the distribution server 300. This saves the user from having to perform an operation for selecting and changing the distribution data to be transmitted.

### <Operations of Digital Camera>

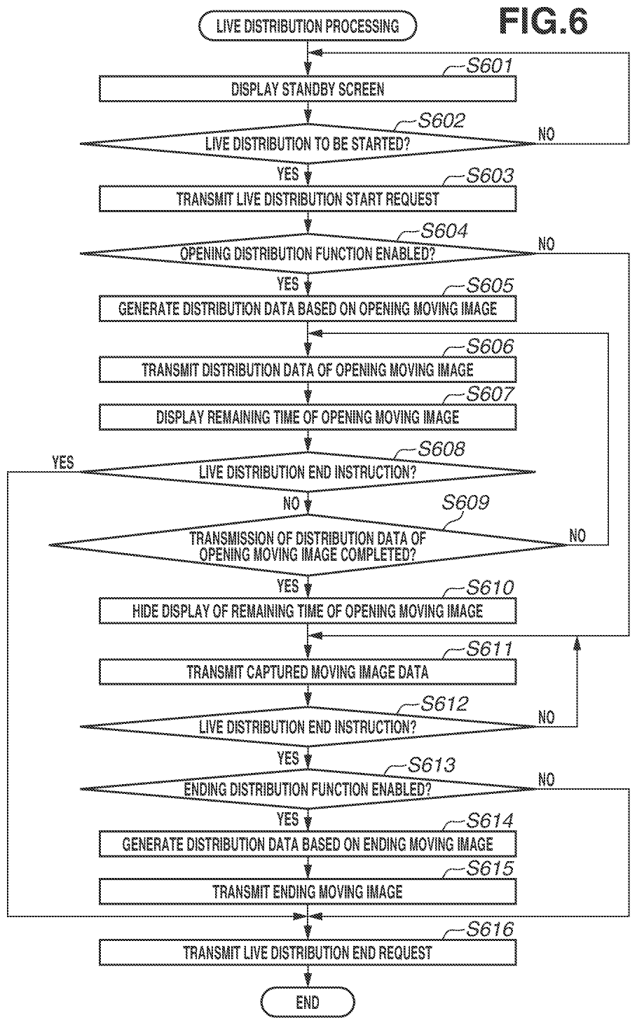

FIG. 6 is a flowchart illustrating an example of an operation of the digital camera 100 according to the present example embodiment. Processing of the digital camera 100 is implemented by the control unit 101 loading software recorded in the nonvolatile memory 103 into the work memory 104 and then executing the software. The start of processing of the digital camera 100 is triggered by the control unit 101 receiving a live distribution start instruction from the user. For example, with the user performing a touch operation to select the button 501 in the screen illustrated in FIG. 5A on the touch panel as trigger, the control unit 101 starts the processing of this flowchart. This trigger is equivalent to the instruction issued in step S401 in FIG. 4.

In step S601, the control unit 101 displays a standby screen on the display unit 106.

For example, as illustrated in FIG. 5A, the control unit 101 successively displays the moving image data currently being generated by the imaging unit 102. In step S601, in a case where the user operates the operation unit 105 to change the image capturing settings, such as the white balance, the control unit 101 changes the image capturing settings in accordance with the user operation. The processing in this step is equivalent to, for example, the processing in step S402 in FIG. 4.

In step S602, the control unit 101 determines whether to start the live distribution. For example, in a case where the user performs the touch operation on the button 501 illustrated in FIG. 5A, the control unit 101 determines that the live distribution is to be started. If the control unit 101 determines that the live distribution is to be started (YES in step S602), the processing proceeds to step S603. If the control unit 101 determines that the live distribution is not to be started (NO in step S602), the processing returns to step S601. The operation in this step is equivalent to, for example, the operation in step S403 in FIG. 4.

In step S603, the control unit 101 transmits a live distribution start request to the distribution server 300 via the communication unit 111. This request includes the identifier and stream key of the live distribution. The operation in this step is equivalent to, for example, the processing in step S404 in FIG. 4.

In step S604, the control unit 101 determines whether the opening distribution function is enabled. For example, the control unit 101 determines whether the item 304 for the opening moving image in FIG. 3D is ON or OFF. In a case where the item 304 is ON, the control unit 101 determines that the opening distribution function is enabled. In a case where the item 304 is OFF, the control unit 101 determines that the opening distribution function is disabled. If the opening distribution function is enabled (YES in step S604), the processing proceeds to step S605. If the opening distribution function is disabled (NO in step S604), the processing proceeds to step S611.

In step S605, the control unit 101 generates the distribution data based on the moving image data that is finalized as the opening moving image. The moving image data finalized as the opening moving image is, for example, one selected by the user in the screen in FIG. 3F. The control unit 101 encodes the moving image data based on the live distribution settings to generate the distribution data. The operation in this step is equivalent to, for example, the processing in step S405 in FIG. 4.

In step S606, the control unit 101 transmits the distribution data generated in step S605 to the distribution server 300, via the communication unit 111. The operation in this step is equivalent to, for example, the processing in step S407 in FIG. 4.

In step S607, the control unit 101 displays the remaining time to completion of the distribution data transmission on the display unit 106. For example, as illustrated in FIG. 5C, the control unit 101 superimposes the time on the moving image data currently being generated by the imaging unit 102. The control unit 101 acquires the remaining time by using the following method. For example, in generating the distribution data from the moving image data of the opening moving image in step S605, the control unit 101 acquires in parallel the reproduction time from the meta data of the moving image data and sets the reproduction time to the remaining time. As another method, for example, the control unit 101 may calculate the time to completion of the transmission based on the amount of the distribution data that has not been transmitted to the distribution server 300 and the current transmission rate, and set the calculated time to the remaining time. The control unit 101 determines whether to display the remaining time to completion of the distribution data transmission, based on the setting of the item 306 in FIG. 3E. If the item 306 in FIG. 3E is ON, the control unit 101 performs the operation in step S607. If the item 306 in FIG. 3E is OFF, the control unit 101 performs the operation in step S608 without performing the operation in step S607. The operation in step S607 is equivalent to, for example, the operation in step S408 in FIG. 4.

In step S608, the control unit 101 determines whether to terminate the live distribution. For example, in the screen illustrated in FIG. 5C, the control unit 101 determines whether a touch operation has been performed on the button 502. If the user has performed the touch operation on the button 502, the control unit 101 determines that the live distribution is to be terminated (YES, in step S608). Examples of use cases where the user terminates the live distribution during the transmission of the opening moving image include a case where the user erroneously starts the live distribution and a case where the user determines that the arrangement and/or image capturing settings of the digital camera 100 is/are to be changed in haste. In such cases, the processing proceeds to step S616, and the control unit 101 terminates the live distribution. In these cases, the ending moving image is not transmitted to the distribution server 300 even if the ending distribution function is ON. This is because it is irregular to terminate the live distribution during the transmission of the opening moving image, and the timing is not suitable for the transmission of the ending moving image. In a case where the control unit 101 determines that the live distribution is not to be terminated (NO in step S608), the processing proceeds to step S609.

In step S609, the control unit 101 determines whether the transmission of the distribution data generated from the opening moving image is completed. For example, in a case where the time to completion of the transmission based on the distribution data amount that has not yet been transmitted to the distribution server 300 and the current transmission rate is to be displayed as the remaining time, the control unit 101 determines that the transmission of the distribution data is completed in response to all of the distribution data having been transmitted. For example, in a case where the reproduction time of the moving image data of the opening moving image is to be displayed as the remaining time, the control unit 101 determines that the transmission of the distribution data is completed in response to the reproduction time of the moving image data having elapsed since the start of the distribution data transmission. If the control unit 101 determines that the transmission of the distribution data generated based on the opening moving image is not completed (NO in step S609), the processing returns to step S606. In step S606, the control unit 101 continues the transmission of the remaining distribution data. If the control unit 101 determines that the transmission of distribution data generated based on the opening moving image is completed (YES in step S609), the processing proceeds to step S610.

In step S610, the control unit 101 erases the display of the remaining time to completion of the distribution data transmission from the display unit 106. The processing in this step is equivalent to, for example, the operation in step S409 in FIG. 4.

In step S611, the control unit 101 generates the distribution data from the moving image data currently being generated by the imaging unit 102 and the audio data currently being generated by the microphone 107 and then transmits the distribution data to the distribution server 300 via the communication unit 111. The operation in this step is equivalent to, for example, the processing in step S410 in FIG. 4.

In step S612, the control unit 101 determines whether to terminate the live distribution. For example, in a case where the user performs the touch operation on the button 502 in the screen illustrated in FIG. 5E, the control unit 101 determines that the live distribution is to be terminated. If the control unit 101 determines that the live distribution is not to be terminated (NO in step S612), the processing returns to step S611 and the operation in step S611 is repeatedly performed. If the control unit 101 determines that the live distribution is to be terminated (YES in step S612), the processing proceeds to step S613. The operation in this step is equivalent to, for example, the processing in step S411 in FIG. 4.

In step S613, the control unit 101 determines whether the ending distribution function is enabled. For example, the control unit 101 determines whether the item of the ending moving image in FIG. 3D is ON or OFF. If the item of the ending moving image is ON, the control unit 101 determines that the ending distribution function is enabled (YES in step S613). If the item of the ending moving image is OFF, the control unit 101 determines that the ending distribution function is disabled (NO in step S613). If the ending distribution function is enabled (YES in step S613), the processing proceeds to step S614. If the ending distribution function is disabled (NO in step S613), the processing proceeds to step S616.

In step S614, the control unit 101 generates the distribution data from the moving image data that is finalized as the ending moving image. The moving image data finalized as the ending moving image is, for example, one selected as the ending moving image by the user, as in the method for determining the opening moving image. The control unit 101 encodes the moving image data based on the live distribution settings to generate the distribution data. The processing in this step is equivalent to, for example, the processing in step S412 in FIG. 4.

In step S615, the control unit 101 transmits the distribution data generated in step S614 to the distribution server 300, using the communication unit 111.

The operation in this step is equivalent to, for example, the operation in step S413 in FIG. 4. The control unit 101 displays the remaining time to completion of the transmission of distribution data on the display unit 106. In response to completion of the distribution data transmission, the control unit 101 hides the display of the remaining time to completion of the distribution data transmission. The processing then proceeds to step S616. The operation in this step is equivalent to, for example, the operation in step S413 in FIG. 4.

In step S616, the control unit 101 transmits a request for the termination of the live distribution to the distribution server 300 via the communication unit 111. The operation in this step is equivalent to, for example, the operation in step S414 in FIG. 4.

This completes the description of operations of the digital camera 100 according to the present example embodiment.

In a case where the live distribution settings are changeable during the live distribution, the control unit 101 may operate in the following way. In performing the operation in step S605, the control unit 101 changes the live distribution settings according to the moving image data of the opening moving image. In a case where the operation in step S611 is performed, the control unit 101 changes the live distribution settings according to the moving image data generated by the imaging unit 102. This eliminates the need for the control unit 101 to subject the moving image data to image processing according to the live distribution settings, thus reducing the processing load in the live distribution processing. A similar operation can also apply to the transmission of the moving image data of the ending moving image.

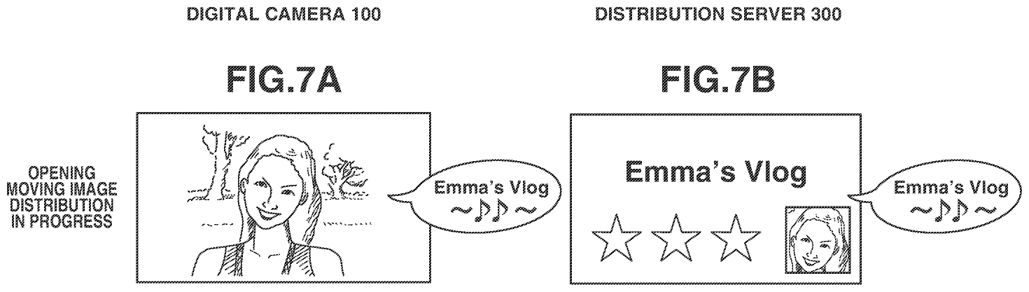

The control unit 101 may reproduce the audio data included in the moving image data of the opening moving image by using the speaker 108 in parallel with the operation in step S607. For example, as illustrated in FIGS. 7A and 7B, the control unit 101 reproduces the sound of the opening moving image at a timing similar to the timing when the sound of the opening moving image to be viewed by the users as viewers is reproduced. This enables the user to time the timing when the moving image data currently being generated by the imaging unit 102 is distributed by the distribution server 300, based on the sound reproduced by the speaker 108, even in a situation where the user cannot view the display unit 106. The function of reproducing the audio data included in the moving image data of the opening moving image via the speaker 108 is enabled by the user turning ON the item 307 in FIG. 3E. The function of reproducing the audio data included in the moving image data of the opening moving image via the speaker 108 may be performed even in a case where the function of displaying the remaining time to completion of the transmission of the distribution data of the opening moving image is OFF.

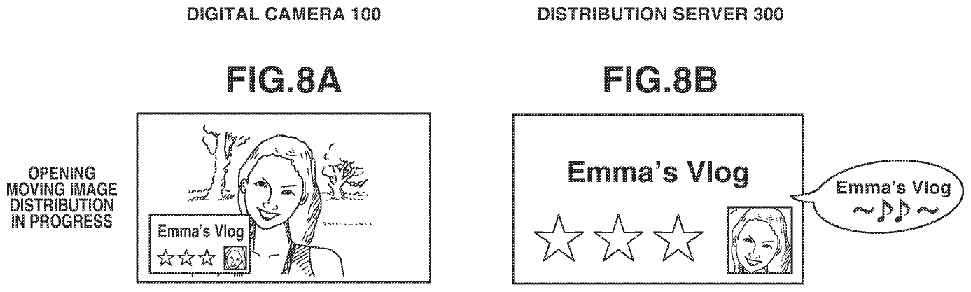

The control unit 101 may display the opening moving image in a wipe screen on the display unit 106 in parallel with the operation in step S607. For example, as illustrated in FIGS. 8A and 8B, the control unit 101 displays the opening moving image on the display unit 106 at a timing similar to the timing when the opening moving image to be viewed by the users as viewers is displayed. Thus, by viewing the display unit 106, the user can time the timing when the moving image data currently being generated by the imaging unit 102 is distributed by the distribution server 300. The function of reproducing the audio data included in the moving image data of the opening moving image using the speaker 108 is enabled by the user turning ON the item 308 in FIG. 3E. The function of displaying the opening moving image in a wipe screen on the display unit 106 may be performed even when the function of displaying the remaining time to completion of the transmission of the distribution data of the opening moving image is OFF. The function of displaying the opening moving image in a wipe screen on the display unit 106 may be performed in parallel with the function of reproducing the audio data included in the moving image data of the opening moving image using the speaker 108.

The operation for starting the live distribution and the operation for terminating the live distribution have been described to be performed by the operation unit 105 of the digital camera 100. The digital camera 100 may receive these operations with other methods. For example, in a case where a remote control is connected via the communication unit 111, the digital camera 100 may determine that the operation for starting the live distribution and the operation for terminating the live distribution are received in response to receiving the signal transmitted from the remote control.

The digital camera 100 switches between ON and OFF of the opening distribution function in the screen illustrated in FIG. 3D. However, the digital camera 100 may switches between ON and OFF of the opening distribution function with other methods. For example, the digital camera 100 may switches between ON and OFF of the opening distribution function depending on whether the moving image data of the opening moving image is stored in a predetermined holder. In this case, in a case where the moving image data is present in the holder, the digital camera 100 determines the moving image data to be the moving image data of the opening moving image. In a case where the control unit 101 determines that the moving image data of the opening moving image is present, the control unit 101 operates in a mode in which the opening distribution function is enabled and determines that the opening distribution function is enabled in step S604 in FIG. 6. On the other hand, in a case where the control unit 101 determines that no moving image data of the opening moving image is present, the control unit 101 operates in a mode in which the opening distribution function is disabled and determines that the opening distribution function is disabled in step S604 in FIG. 6. A similar configuration can apply to the ending distribution function. In a case where the moving image data of the opening and the ending moving images are stored in the same holder, the digital camera 100 may refer to the file name to determine whether the moving image data is the moving image data of the opening moving image, the ending moving image, or other moving images. For example, in a case where the digital camera 100 determines that the file name include a character string “opening”, the digital camera 100 determines the moving image data as the moving image data of the opening moving image. For example, in a case where the digital camera 100 determines that the file name include a character string “ending”, the digital camera 100 determines the moving image data as the moving image data of the ending moving image. For example, in a case where the digital camera 100 determines that the file name include none of the two character strings, the digital camera 100 determines that neither the opening moving image nor the closing moving image exists.

### Other Example Embodiments

Various embodiments of the present disclosure can also be realized when a program for implementing at least one of the functions according to the above-described example embodiments is supplied to a system or apparatus via a network or storage medium, and at least one processor in a computer of the system or apparatus reads and executes the program. Various embodiments of the present disclosure can also be achieved by a circuit (for example, an Application Specific Integrated Circuit (ASIC)) for implementing at least one function.

Embodiments of the present disclosure are not limited to the above-described example embodiments. Rather, in the implementation stage, the described components can be modified and embodied without departing from the spirit and scope of the invention. Diverse embodiments can be formed by suitably combining the plurality of components disclosed in the above-described example embodiments. For example, some of the components may be removed from some of the example embodiments. Further, the components of different example embodiments may be suitably combined.

Various embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While example embodiments have been described, it is to be understood that the invention is not limited to the disclosed example embodiments. The scope of the following claims is to be accorded the broadest interpretation so as to encompass all such modifications and equivalent structures and functions.

This application claims the benefit of Japanese Patent Application No. 2021-058483, filed Mar. 30, 2021, which is hereby incorporated by reference herein in its entirety.

What is claimed is:

1. A communication apparatus comprising:
an imaging unit;
a recording unit;
a control unit; and
a communication unit
wherein the control unit controls the imaging unit to generate first moving image data, and
wherein, in starting transmission of the first moving image data currently being generated by the imaging unit to an external apparatus, the control unit controls the communication unit to automatically transmit second moving image data different from the first moving image data, before starting the transmission of the first moving image data, wherein the second moving image data is recorded in the recording unit.

2. The communication apparatus according to claim 1, wherein, after completion of transmission of the second moving image data to the external apparatus, the control unit performs control to start the transmission of the first moving image data currently being generated by the imaging unit.

3. The communication apparatus according to 1, wherein, in a case where the transmission of the first moving image data currently being generated by the imaging unit to the external apparatus is terminated, the control unit performs control to transmit third moving image data recorded in the recording unit to the external apparatus after completion of the transmission of the first moving image data to the external apparatus.

4. The communication apparatus according to claim 1, further comprising an operation unit, wherein, in a case where the operation unit receives an operation for transmitting the first moving image data currently being generated by the imaging unit to the external apparatus, the control unit starts transmission of the second moving image data recorded in the recording unit to the external apparatus.

5. The communication apparatus according to claim 1, wherein the control unit performs control to notify that transmission of the second moving image data is in progress.

6. The communication apparatus according to claim 1, further comprising a speaker, wherein the control unit controls the speaker to reproduce sound of the second moving image data, in parallel with transmission of the second moving image data.

7. The communication apparatus according to claim 1, further comprising a display unit, wherein the control unit controls the display unit to display a remaining time to completion of transmission of the second moving image data currently being transmitted by the communication unit, the remaining time displayed in parallel with the transmission of the second moving image data.

8. The communication apparatus according to claim 1, further comprising a display unit, wherein the control unit controls the display unit to display the second moving image data together with the first moving image data currently being generated by the imaging unit, in parallel with transmission of the second moving image data.

9. The communication apparatus according to claim 1, wherein the control unit performs control to sequentially transmit the first moving image data currently being generated by the imaging unit to the external apparatus.

10. The communication apparatus according to claim 1, wherein the control unit performs control so that moving image data to be served as content provided to a user is transmitted by a cloud service provided by the external apparatus.

11. The communication apparatus according to claim 10, wherein the cloud service is a live distribution service.

12. A control method for a communication apparatus including an imaging unit, a recording unit, and a communication unit, the control method comprising:
controlling the imaging unit to generate first moving image data; and
controlling, in starting transmission of the first moving image data currently being generated by the imaging unit to an external apparatus, the communication unit to automatically transmit second moving image data different from the first moving image data, before starting the transmission of the first moving image data, wherein the second moving image data is recorded in the recording unit.

13. A non-transitory recording medium recording a program for causing a control method for a communication apparatus including an imaging unit, a recording unit, and a communication unit, the control method comprising:
controlling the imaging unit to generate first moving image data; and
controlling, in starting transmission of the first moving image data currently being generated by the imaging unit to an external apparatus, the communication unit to automatically transmit second moving image data different from the first moving image data, before starting the transmission of the first moving image data, wherein the second moving image data is recorded in the recording unit.
